(19) United States
(12) Patent Application Publication
(10) Pub. No.: US 2024/0339641 A1
(43) Pub. Date: Oct. 10, 2024

(54) METHOD FOR STARTING A FUEL CELL SYSTEM

(71) Applicant: Robert Bosch GmbH, Stuttgart (DE)

(72) Inventor: Helerson Kemmer, Vaihingen (DE)

(21) Appl. No.: 18/699,638

(22) PCT Filed: Oct. 14, 2022
(86) PCT No.: PCT/EP2022/078699

§ 371 Date: Apr. 9, 2024

(30) Foreign Application Priority Data
Oct. 19, 2021 (DE) 10 2021 211 793.7

(51) Int. Cl. H01M 8/04302; H01M 8/04225; H01M 8/04746

(52) U.S. Cl. CPC H01M 8/04302; H01M 8/04225; H01M 8/04776

(57) ABSTRACT

The invention relates to a method for starting a fuel cell system (1), the fuel cell system (1) comprising a fuel cell stack (101), an air path (10), an exhaust gas line (12) and a fuel line (20) having a recirculation circuit (50). Prior to the starting process, a first valve (61) in the air line (10) and a second valve (62) in the exhaust gas line (12) are closed. The method comprises the following steps:
a. starting an air compactor (11) in the air path (10);
b. throttling a pressure controller (63) in the exhaust gas line so that a pressure greater than 1.5 bar is generated upstream of the pressure controller (63);
c. opening the first valve (61) or the second valve (62) after the anode (103) has been flushed with hydrogen;
d. reducing the flow through the bypass valve (65);
e. opening the first valve (61) or the second valve (62) so that the first valve (61) and the second valve (62) are open;
f. closing the bypass valve (65);
g. dethrottling the pressure controller so that the pressure in the exhaust gas line (12) corresponds approximately to the target pressure for the starting process.

### BACKGROUND

The present invention describes a method for starting a fuel cell system.

Hydrogen-based fuel cell systems are considered to be the mobility concept of the future, because they only emit water as exhaust gas and enable fast fueling times. In this context, cell systems need air and hydrogen for the chemical reaction within the cells. In order to supply the required amount of energy, the fuel cells arranged within a fuel cell system are interconnected to form so-called fuel cell stacks. The waste heat of the cells is in this case dissipated by means of a cooling loop and released to the environment. The hydrogen required for operating fuel cell systems is generally provided to the systems from high pressure tanks.

When a fuel cell system is started, the air compressor is typically started to provide sufficient dilution of the hydrogen flushed during anode flushing. After sufficient anode flushing, the cathode shut-off valves (first valve in the air path and second valve in the exhaust path) are opened, air enters the cathode, and the fuel cells provide electrical power.

### SUMMARY

The method according to the invention serves to provide an operating strategy for quickly filling the cathode with air when starting (under freezing conditions) by briefly throttling the air mass flow. The method according to the invention offers the advantage of ensuring a uniform and rapid increase of the cell voltages before a (cold) start of the fuel cell system. The rapid and uniform increase in cell voltages prevents or delays freezing, particularly of the edge cells, and ensures a more robust and faster starting process.

A uniform and rapid increase in cell voltages during the start of fuel cell system reduces the dwell time of the edge cells, which are conventionally supplied with air earlier, at the maximum cell voltage OCV (open cell voltage), which is detrimental to the service life, and thus increases the overall service life of the fuel cell stack.

According to the prior art, the first filling of the cathode is performed at low pressure, whereby the pressure controller in the exhaust gas line is open so that the pressure in the exhaust gas line is close to the ambient temperature. Filling the cathode until all cells are sufficiently filled with air or oxygen typically takes some time under these boundary conditions. As a result, the increase in voltage within the fuel cell stack is not uniform. The edge cells are the first to receive a good supply of oxygen, and their voltages increase correspondingly earlier. These cells are also the first whose voltage drops, presumably due to icing of the cathode or anode channels. This is due to the fact that the fuel cell reaction starts early in these cells without the current being fully applied. As a result, water is produced locally in the absence of sufficient heat, thus favoring or causing icing. Furthermore, for the reason specified hereinabove, these cells remain in OCV for a longer period of time, resulting in increased degradation. This effect can be avoided by the method according to the invention, so that the fuel cell experiences less degradation.

In the method according to the invention for starting a fuel cell system, the fuel cell system comprises a fuel cell stack, an air path, an exhaust gas line, and a fuel line having a recirculation circuit, whereby, prior to the starting process, a first valve in the air line and a second valve in the exhaust gas line are closed and the bypass valve is opened, said method comprising the following steps:
a. starting an air compressor in the air path;
b. throttling a pressure controller in the exhaust gas line so that a pressure greater than 1.5 bar is generated upstream of the pressure controller;
c. opening the first valve (61) or the second valve (62) after the anode (103) has been flushed with hydrogen;
d. reducing air flow through the bypass valve (65);
e. opening the first valve (61) or the second valve (62) so that the first valve (61) and the second valve (62) are open;
f. closing the bypass valve (65);
g. dethrottling the pressure controller so that the pressure in the exhaust gas line (12) corresponds approximately to the target pressure for the starting process.

In one embodiment of the invention, in which the second valve is opened in step c while the first valve remains closed, the initial filling of the cathode with oxygen occurs from the back to the front. Potential ice production does not take place in the entry area of the cathode, but in the exit area. This is advantageous because these chunks of ice can be removed more easily by the flow direction specified during normal operation.

Advantageous embodiments and developments of the method according to the invention are specified in the dependent claims.

It is advantageous for the pressure controller to be dethrottled after filling the cathode with air containing oxygen so that the pressure in the exhaust gas line corresponds approximately to the ambient pressure. By approaching the ambient pressure, the compressor in the air line must use a low amount of energy to supply the stack with air

A further advantage arises if a pressure of 2 bar is set during method step b) because this value has led to particularly good results in the prevention of cell degradation in measurements.

If method steps c.) and d.) are performed almost simultaneously and quickly, this is advantageous because damage to the valves due to an undesirable excessive high pressure can be prevented.

It is advantageous if the throttling or dethrottling of the pressure controller is controlled by measuring the cathode outlet pressure. In this case, both the pressure behind the air compressor and the pressure between the stack and the second valve is measured.

A particular advantage arises when the throttling or dethrottling of the pressure controller occurs in a pilot-controlled manner by approaching of one or two predetermined positions, because the pilot-controlled operation also works well with a frozen pressure sensor.

A brief increase in the mass flow of the air compressor during cathode filling advantageously results in a shortened start time.

Increasing the pressure in the recirculation circuit during flushing of the anode is advantageous, particularly when the purge line upstream of the pressure control valve opens into the exhaust path.

The method according to the invention can be used in particular in fuel cell-powered motor vehicles. However, it is also conceivable to use the method in other fuel cell-powered transportation means, such as cranes, ships, rail vehicles, flying objects, or even in stationary fuel cell-powered objects.

### BRIEF DESCRIPTION OF THE DRAWINGS

Shown are:

FIG. 1 a schematic representation of a fuel cell system according to the invention and

FIG. 2 a flowchart of the individual steps of a method according to the invention.

### DETAILED DESCRIPTION

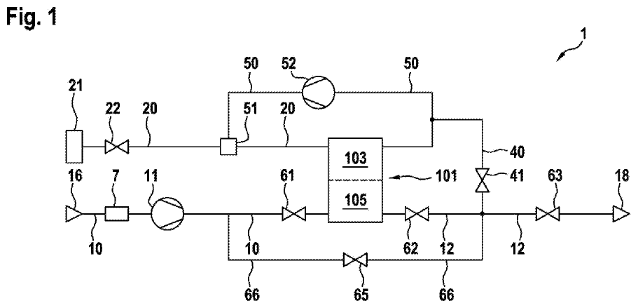

FIG. 1 shows a schematic topology of a fuel cell system 1 according to a first exemplary embodiment of the invention, having at least one fuel cell stack 101. The at least one fuel cell system 1 comprises an air path 10, an exhaust gas line 12, and a fuel line 20. The at least one fuel cell stack 101 can be used for mobile applications with a high power specification, for example in trucks, or for stationary applications, for example in generators.

The air path 10 serves as an air supply line for supplying air from the environment to a cathode 105 of the fuel cell stack 101 via an inlet 16. Components needed for the operation of the fuel cell stack 101 are arranged in the air path 10. An air compressor 11 and/or compressor 11, which compresses and/or draws in the air in accordance with the respective operating conditions of the fuel cell stack 101, is arranged in the air path 10. A heat exchanger 15 which heats the air in the air path 10 can be located downstream of the air compressor 11 and/or the compressor 11.

Further components, e.g. a filter 7 and/or a humidifier and/or valves, can be provided in the air path 10. Air containing oxygen is made available to the fuel cell stack 101 via the air path 10.

The fuel cell system 1 also comprises an exhaust gas line 12, in which water and other components of the air from the air path 10 are transported into the environment via an outflow 18 after passing through the fuel cell stack 101. The exhaust gas of the exhaust gas line 12 can also contain hydrogen (H2), because portions of the hydrogen can diffuse through the membrane of the fuel cell stack 101 or are conveyed via a purge line 40 into the exhaust gas line 12.

The air path 10 is connected to the exhaust gas line 12 via a bypass line 66. A bypass valve 65 is arranged within the bypass line 66 in order to direct air from the air path 10 past the fuel cell stack 101 to the exhaust gas line 12.

A first valve 61 is arranged in the air path 10 between the inlet of the bypass line 66 and the cathode 105 of the fuel cell stack 101, and a second valve 62 is arranged in the exhaust gas line 12 between the outlet of the bypass line 66 and the cathode 105 of the fuel cell stack 101. By closing the first valve 61 and the second valve 62, the cathode 105 can be held at a fixed pressure level or protected against an undesired pressure drop during complete shutdown or temporary shutdown (e.g., during a start-stop process).

The fuel cell system 1 can moreover comprise a cooling loop designed to cool the fuel cell stack 101. The cooling loop is not shown in FIG. 1, because it is not part of the invention.

A high pressure tank 21 and a shut-off valve 22 are located in the inflow of fuel line 20. Additional components can be arranged in the fuel line 20 so as to supply fuel to an anode side 103 of the fuel cell stack 101 as needed.

In order to always adequately supply the fuel cell stack 101 with fuel, there is a need for an over-stoichiometric metering of fuel via the fuel line 20. The excess fuel, and also certain amounts of water and nitrogen that diffuse through the cell membranes to the anode side, are recirculated in a recirculation circuit 50 and mixed with the metered fuel from the fuel line 20.

Various components, such as a jet pump 51 operated with the metered fuel or a blower 52, can be installed in order to drive the flow in the recirculation circuit 50. A combination of jet pump 51 and blower 52 are possible as well.

A pressure control valve 63 is arranged in the exhaust gas line 12, which can throttle the flow in the exhaust gas line so that different pressures can be adjusted upstream of the pressure control valve.

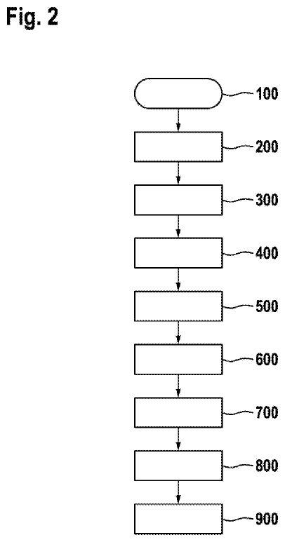

FIG. 2 shows a flowchart of the individual steps of a method according to the invention for starting a fuel cell system 1.

In method step 100, the fuel cell system 1 is started. Prior to the starting process, the first valve 61 in the air line 10 and the second valve 62 in the exhaust gas line 12 must be closed and the bypass valve 65 must be open for the method to be performed properly.

In method step 200, the air compressor 11 is started in the air path.

In method step 300, the pressure controller 63 in the exhaust gas line is throttled so that a pressure greater than 1.1 bar is produced upstream of the pressure controller 63. In a further embodiment of the method according to the invention, the pressure controller is adjusted so as to produce a pressure greater than 2 bar.

In a method step 400, the anode 103 is flushed with hydrogen. For this purpose, the fuel line 20 and the recirculation circuit 50 are filled with hydrogen via the high-pressure tank 21 and the shut-off valve 22. In order to remove interfering residual gases or water from the recirculation circuit 50, a purge valve 41 in the purge line 40 is opened for a short time during flushing of the anode. The pressure in the recirculation circuit 50 can be briefly increased during flushing of the anode 103 to shorten the flushing process.

In method step 500, the first valve 61 is opened while the second valve 62 remains closed. In an alternative embodiment of the method according to the invention, the second valve 62 is opened while the first valve 61 remains closed.

In method step 600, the bypass valve 65 is closed as far as possible, so that the mass flow through the bypass valve 65 is as low as possible, but pumping of the air compressor 11 or compressor 11 is prevented at the same time.

Alternatively, a period of time can be allowed to elapse, so that oxygen can enter the cathode. This period of time can be purely pilot controlled, or can be controlled by means of the pressure progression in the air system: After method step 500, the pressure in the air system drops due to the additional stack volume. After the pressure has been regulated again, the cathode has been filled with air containing oxygen.

In an alternative embodiment of the method, method steps 500 and 600 are performed as simultaneously as possible.

In method step 700, the first valve 61 or the second valve 62 is opened so that the first valve 61 and the second valve 62 are open.

In method step 800, the bypass valve 65 is closed fully.

Alternatively, a period of time can be allowed to elapse until the cathode has been fully flushed with air containing oxygen. This period of time can be purely pilot operated, or it can be controlled by means of the pressure progression in the air system: After opening the previously closed valve, the pressure in the air system breaks down again due to the additional air path. After the pressure has been regulated again, the cathode will be filled with air containing oxygen.

In method step 900, the pressure controller 63 is dethrottled so that an air pressure is set in the exhaust gas line 12, which corresponds approximately to the target pressure for the start operation.

The throttling or dethrottling pressure controller 63 can be controlled by measuring or calculating the cathode outlet pressure in the exhaust gas line 12 between the cathode 105 and the second valve 62.

Alternatively, the throttling or dethrottling of the pressure controller 63 is performed in a pilot-controlled manner by approaching one or two previously established positions.

1. A method for starting a fuel cell system (1), wherein the fuel cell system (1) comprises a fuel cell stack (101), an air path (10), an exhaust gas line (12), and a fuel line (20) having a recirculation circuit (50), wherein, prior to a starting process, a first valve (61) in the air path (10) and a second valve (62) in the exhaust gas line (12) are closed and the bypass valve (65) is opened, said comprising the following steps:
a. starting an air compressor (11) in the air path (10);
b. throttling a pressure controller (63) in the exhaust gas line so that a pressure greater than 1.1 bar is generated upstream of the pressure controller (63);
c. opening the first valve (61) or the second valve (62) after the anode (103) has been flushed with hydrogen;
d. reducing a flow through the bypass valve (65);
e. opening the first valve (61) or the second valve (62) so that the first valve (61) and the second valve (62) are open;
f. closing the bypass valve (65);
g. dethrottling the pressure controller (63) so that the pressure in the exhaust gas line (12) corresponds approximately to a target pressure for the starting process.

2. The method according to claim 1, wherein, in method step b.), a pressure of 2 bar is set.

3. The method according to claim 1, wherein method steps c.) and d.) are performed at nearly the same time.

4. The method according to claim 1, wherein the throttling or dethrottling of the pressure controller (63) is controlled by measuring a cathode outlet pressure.

5. The method according to claim 1, wherein the throttling or dethrottling of the pressure controller (63) is performed in a pilot-controlled manner by approaching one or two predetermined positions.

6. The method according to claim 1, wherein a mass flow of the air compressor (11) is briefly increased.

7. The method according to claim 1, wherein the pressure in the recirculation circuit (50) is increased during flushing of the anode (103).

8. The method according to claim 1, wherein a pressure in the recirculation circuit (50) is increased during steps a.) to d.).

9. The method according to claim 8, wherein, after filling the cathode (105) with oxygen-containing air, the pressure in the recirculation circuit (50) is reduced.

10. The method according to claim 1, wherein the pressure in the exhaust gas line (12) corresponds approximately to an external pressure when the pressure controller (63) is dethrottled in step g.

11. The method according to claim 10, wherein the throttling or dethrottling of the pressure controller (63) is controlled by measuring a cathode outlet pressure.

12. The method according to claim 10, wherein the throttling or dethrottling of the pressure controller (63) is performed in a pilot-controlled manner by approaching one or two predetermined positions.
